(19) United States
(12) Patent Application Publication
(10) Pub. No.: US 2008/0189553 A1
(43) Pub. Date: Aug. 7, 2008

(54) MEMORY BASED AUTHENTICATION SYSTEM

(76) Inventors: David Eppert, Delta (CA); Martin L. Renaud, Maple Ridge (CA)

Correspondence Address: Davis Wright Tremaine LLP/Portland, 1300 S.W. Fifth Avenue, SUITE 2300, Portland, OR, 97201-5630, US

(21) Appl. No.: 11/309,300

(22) Filed: Jul. 24, 2006

Related U.S. Application Data
(63) Continuation-in-part of application No. 11/161,116, filed on Jul. 22, 2005.

(51) Int. Cl. H04L 9/00

(52) U.S. Cl. 713/183

(57) ABSTRACT

An authentication system for authenticating an identity of a user which has a database having a plurality of training questions about the user's past and a corresponding testing question for each of the training questions stored thereon. The authentication system also has a central processing unit (CPU) coupled to the database and is operative in both a training session and a testing session to select a sub-set of the training questions and to pose them to the user, store user responses to the subset of training questions in the user's profile and, in said testing session and to select a subset of the testing questions. The subset of testing questions is posed to the user and the responses of said user to said subset of test questions checked against the user's profile. Each of the testing questions is based on a corresponding training question without a context.

### RELATED APPLICATIONS

This application is a Continuation in Part of U.S. patent application Ser. No. 11/161,116, filed on Jul. 22, 2005.

This application claims priority of previously filed U.S. patent application Ser. No. 11/161,116, filed on Jul. 22, 2006.

### FIELD

The present invention relates to a user authentication system based upon memories and memory processes. Unique life experiences are used to ensure others do not gain access to personal information.

### BACKGROUND

Authenticating the user of a computer system is the process of determining that the user is who he/she claims to be. The most common authentication technique is the user name and password. The former provides identity credentials while the latter provides authentication credentials. When faced with choosing a password of 5-10 characters in length, composed of letters and numbers, most people choose short, simple passwords that can be easily remembered. Modern computers can ascertain such passwords very easily. Moreover, using such passwords for long periods of time or on multiple systems increases the risk of that password being compromised. Some systems force a user to rotate or change their passwords on a regular basis but this makes the memory burden of a password system much larger and people tend to make less secure password choices if they are forced to make them often. Sharing passwords with spouses, secretaries, etc. for convenience, compromises the ability of a system to uniquely identify an individual and increases the chance that a password will be misused.

Hardware authentication is another type of authentication, which requires the presence of the hardware token, which is commonly a card with a magnetic strip. Token authentication does not require the presence of the “true” person. Such authentication systems are expensive and yet confirm only the presence of the token and not the presence of the person.

Biometric implementations of authentication systems can be static such as fingerprints, eye retinas and irises, voice patterns, facial patterns and hand measurements, or dynamic such as signature, gait, voice or typing. Static biometrics are relatively easy to measure, and the technology comparatively mature. Authentication systems that rely on static biometrics must be carefully implemented because poorly implemented systems can be subject to particularly pernicious forms of identity theft. For example, the theft of a thumbprint can have long-lasting implications, since—unlike a password—it is not easily changed.

Dynamic biometrics are unique, often unconscious behaviors of an individual. Signature biometrics measures the manner in which an individual creates his/her signature and not just the static visual image of his/her signature. Dynamic features measured include speed, pen pressure, vector, stroke length and pen-lifts. Authentication systems that rely on dynamic biometrics do not suffer from the identity theft issues to which static biometrics are prone. However strong, dynamic biometric authentication systems are expensive and require a hardware device to take the required measurements at every access point. For example, if the user has a dynamic signature tablet for authentication on their office desktop computer, he/she will need another similar device at home to achieve the same level of security when working from home, effectively doubling the cost of the solution.

There is clearly needed in the marketplace a mechanism as simple and as easy to use as a password.

### SUMMARY OF THE INVENTION

According to the invention there is provided an authentication system for authenticating an identity of a user. The system has a database with a plurality of training questions selected from the group consisting of a user's past life, mnemoseny, and resonance and a corresponding testing question for each of the training questions stored thereon. The authentication system also has a central processing unit (CPU) coupled to the database and is operative in both a training session and a testing session to select a sub-set of the training questions and to pose them to the user, store user responses to the subset of training questions in the user's profile and, in said testing session to select a subset of the testing questions. The subset of testing questions is posed to the user and the responses of said user to said subset of test questions checked against the user's profile. Each of the testing questions is based on a corresponding training question with or without a context.

Key words in the training questions are replicated in the test questions so that both the training questions and the corresponding testing questions have the same key words. The repetition of those words assists users in providing the same answers to corresponding training and testing questions.

Advantageously, the system augments current authentication systems already in place. For example, access to the authentication system can be controlled by a conventional user name and password sign-on protocol.

Responses to questions may be made by selecting a letter on an alphabetic selection grid.

Advantageously, the database has a log of pass and fail recordals for each training/test question pair and for each user.

Advantageously, a time out circuit monitors and is operative to limit the duration of each of the training and test questions.

Advantageously, each of the training questions follows a common format so that users may easily and consistently follow instructions.

A central processing unit (CPU) is coupled to the database and is operative to select a subset of training and testing questions wherein the testing questions in a subset of testing questions are randomly selected.

Preferably, the training questions do not elicit any identifying information.

Advantageously, a performance monitor records passes and fails for each test question for each user.

The training and testing questions may create a feeling of nostagia in a user, they may deal with things that have never been experienced or seen by anyone, i.e., mnemoseny, or they may employ resonance.

Preferably, an ID monitor records session identification time and computes and records average session identification time.

In another aspect of the invention there is provided a method of authentication, which includes providing a database having training questions and testing questions, user responses to those training questions as part of a user profile. Each of the testing questions is based on a corresponding training question and the testing questions may or may not contain context. The training questions are questions about events selected from the group consisting of a user's past life, mnemoseny, and resonance. During a training session a subset of the training questions is selected from the database and displayed to the user. The method further includes storing responses to said training questions in the user profile on said database and, during a testing session, randomly selecting subsets of the training questions from the database and displaying those training questions to the user, storing responses to the training questions in the user profile on the database, selecting a subset of the testing questions from the database and displaying those testing questions to the user and checking a response to each question of the subset of testing questions against responses stored in the user profile to determine if the response to the testing question is a pass or fail.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a schematic diagram of the authentication system and a user;

FIG. 2 is a schematic diagram of an alternate configuration for the authentication system; and

FIG. 3 is a schematic diagram of the system using the Internet.

FIG. 4 is a schematic diagram of the configuration of the system for users accessing information from a clients server and/or database.

### DETAILED DESCRIPTION WITH REFERENCE TO THE DRAWINGS

To ensure that a person with whom a company expects to be doing business is present during a login, the present system verifies that person's presence by asking simple questions about that person's unique life experiences, using memories and memory processes as the access key. The present system is also applicable to ATM's enabling devices (e.g., PDA's), account access, etc. It uses recognition and knowledge recall (as opposed to event recall) in order to assure ease of use. Typical users require only a few minutes to begin using the system and, after a few sessions, less than a minute to be authenticated. Session duration depends on the level of security desired by the establishment that uses the system. Three distinct categories of questions are available to clients to choose, in accordance with their security needs.

### Nostalgia

The first category of questions is characterized by nostalgia. A feeling of nostalgia creates its own unique memory that enables a user to repeatedly provide the same response to a given question in the future. The questions are about events that span a user's life from early childhood to early adulthood. Each question asks a user to recall a specific event, or characteristic of an event, from the past. The questions are non-trivial solutions to user identification which exploit processes of remembering and feelings of recall.

### Examples of Training and Testing Questions:

### Alpha-Numeric Selection

A set of questions is constructed based on specific themes, some of which will be more appropriate for some users than others. As questions are designed and tested, a specific profile of questions will emerge that will be different for each user and client. For each of the following questions you should get a clear visual image of the answer in your mind. This image should quickly and easily come to mind. You will answer by selecting the first letter of the name of that image below. If no clear image comes to mind, simply select “nothing” and move on.

### Theme: Education

1) You attended a variety of schools in you life. What is the name of the second school you attended? (Clearly picture that school in your head. Enter the first letter of its name).
At test: this question type allows for the simplest form of security.
At test: this question allows for the simplest form of security. Although sibling of the user may also be able to answer it, people who do not know the user will not be privy to this information.

### Theme: Childhood Playtime

2. As a child what was the name of one specific toy that you wish that you still owned. Try to visualize the details of that toy and enter its first letter.
At test: this question can be presented in a variety of ways to get at the same information. This type of information is as likely to be known by family or friends as the previous type.

These questions are secure enough for most corporate needs. They do not guarantee the highest levels of security since close family members and long-term friends may share experiences relevant to some of the answers. Also in close-knit communities, small towns and environments where people have had a very stable, non-changing upbringings, the variability of past experiences may be low across individuals. For these reasons many clients will want to supplement their profiles with questions from a second category.

### Mnemoseny

The ability of human memory to create memories of things that they have never experienced or that have never been seen by anyone else is exploited extensively and directly in formulating a second category of questions that at first seem unusual and yet are easy to complete and, in many circumstances, are enjoyable. These questions are structured to encourage users to create a singularly meaningful memory by juxtaposing ordinary objects, terms or emotions in unusual ways. Unlike a system which obtains a profile based mostly on the user's past experiences, the second category of questions will create a mnemonic profile of new, highly memorable, and unique experiences. They also allow for a level of variability in responses across users not possible with the aforementioned system. Variability of responses is not a function of the differences in people's life experiences; it is mostly dependent on the structure of the questions posed to users. This permits a higher level of control over the security of the system. The benefits of these questions must be balanced by the potential costs of users discussing and sharing these new, unique experiences with friends and colleagues. For example, users working at repetitive jobs, with little novelty in their day, may find the desire to share the unusual experience of these questions irresistible. The second category of questions, therefore, require extensive testing and development by a research team. So, although the present questions are more costly to add to a client's profile, when security needs are moderate to high, the benefits of including them far outweigh the costs. The following are examples of questions that might be used in Mnemonseny:

### Multiple Labeled Selection:

Category: Animals

1) Mythical creature: From the list below select two animals that you could envisage being used in a science fiction movie to create an unusual battle scene. Pick the first animal from this set, then the selections will change for you to choose the second animal
The description of why they are doing this is important to make the event memorable. If the experience is not given a clear reason for happening, most people will forget it over subsequent weeks.
The selection set can contain any number of animals, all labeled by their names and a picture of the animal.
Their first choice will determine what set will be shown for the second choice. If they choose a small timid animal (mouse) then the next set will include larger animals and more dangerous animals (lion).
After selection they will be shown a chimera or composite animal as the animal that the director came up with for the movie.
   At test: half of the animal could be shown and the user could be asked for the other half, or a range of chimeras could be shown and the user is asked for theirs.

Category: Non-Words

2) An advertiser needs a name for a new (put in a name of an item seen by users in the context of their jobs or user environment). To create this unique six (can be varied) letter word, please choose two of the following partial words.
Similar to the selection process above except a combination of a fluent and non-fluent ending will create the uniqueness of the combination word)
E.g., Fip can be combined with OLY for some users for a fluent word and with Bog for other users
They are shown the word and told to envisage how the advertiser will convince others that this name is the best thing he has ever heard (or some other complimentary expression that makes the user feel very good).

### Resonance

If very high security needs are required, a third category of questions that establishes the presence of a user requiring unique information (based on past memorial responses) and that allows for the use of information that has never been previously entered into the system is needed. The third category of questions is designed to satisfy this highest level of security. Resonance is the quality of a memorial experience. That quality is determined more by how people have used their memory in the past, rather than by what those memories contain. This third category of questions works by establishing true “metrics” of an individual's memory processing.

Each person has a unique way of using his or her memories. The same information presented to two people will always be processed in two separate and distinct ways. The questions used in the third category of questions are designed to initially establish each person's own way of characterizing the testing situation. They subsequently authenticate the user based on similarities in how specifically modified testing situations affect responses. The metrics that are used, of course, are designed based on the latest research in Cognitive processes and extensively tested to establish their efficacy. Furthermore, each of the metrics used in the third category of questions is a non-intuitive extension of the authentication solution. They exploit the design characteristics of human memory.

### Variable Training Sets

In the following, a variety of very unique presentation sets are used to permit the computation of a variety of cognitive processing metrics for each user. These metrics then establish user presence. These methods are non-intuitive.

1) Estimation analysis: These are the simplest types of resonance questions. People are extremely quick to apply an estimate to a mathematical equation, even when they feel mathematically inept. They do this by applying simple heuristic strategies. Those estimates are systematically imprecise: they are not accurate but we can control how inaccurate they are by modifying the format of the question
a. E.g. Factorial: 8! or 8×7×6 . . . ×1 is estimated by people to be around 5000 but when presented as 1×2×3×8 it is estimated to be around 1500. That huge difference is the nomothetic effect. These types of estimations also reveal an ideographic (individual) effect of estimate correct when the correct answer is given (44320). People don't remember the answer for a long time, but they remember that it is larger and on a subsequent occasion will increase their estimate by an amount that reveals their own estimation style.
b. At test: user's unique answer to this question will not depend on how the question is posed at test though it will for attempts made by non-users.

2) Deese effects: although researched for over 30 years, Deese lists have not been exploited for security purposes. The basic idea is to present a list of related words very rapidly leaving out the theme word for the list. E.g., bed, sheets snore, rest, pillow, slumber . . . . The theme word “sleep” is shown at a latter time and people asked if it was in the list. People almost always say yes it was. If given a choice between that theme word and a word that was in the list (like “bed”) they will say that bed was not in the list, and sleep was. This is the Deese effect. Resonance will take advantage of this effect by reversing it for some training lists. A metric can be calculated for accuracy and inaccuracy expectations for each individual. The methods of reversing the effect are not well known in the literature.

3) Incorporating the third category of questions into a client's profile requires more initial training sessions than either of the first or second categories of questions. Obtaining a reliable user profile may require four or five training sessions before a reliable measure of an individual user is obtained. Ideally this will occur while the user is gaining experience using both the first and second category of questions, and therefore, just like the users who only experience those two types of questions, users who also get resonance questions will not notice any difficulty or experience any frustration with the process.

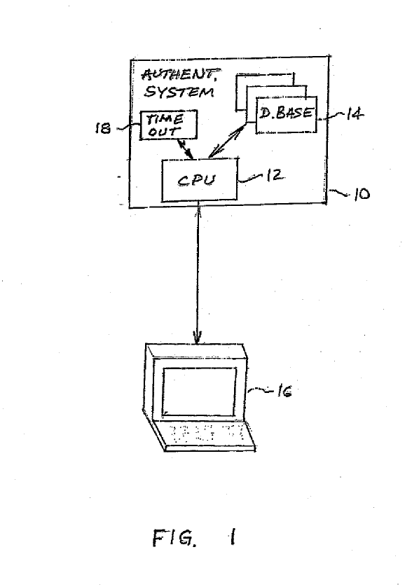

Referring to FIG. 1, the hardware for a preferred authentication system 10 includes a central processing unit 12 and a database 14 coupled to the CPU 12. A user computer 16 couples to the CPU 12. A time out circuit 18 also couples to the CPU 12 and controls the duration of time allowed for responding to any training or testing question.

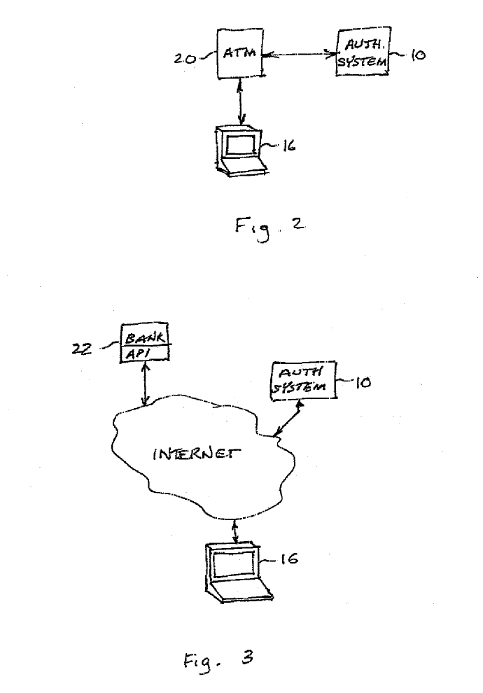

Referring to FIG. 2, the user represented by computer 16 is coupled to an ATM machine 20 which, in turn, is coupled to authentication system 10. Once a user has inserted his/her pin number and bank card, he/she are connected with authentication system 10 through the ATM machine 20. After a few testing questions are successfully answered by the user, access is provided to his/her account.

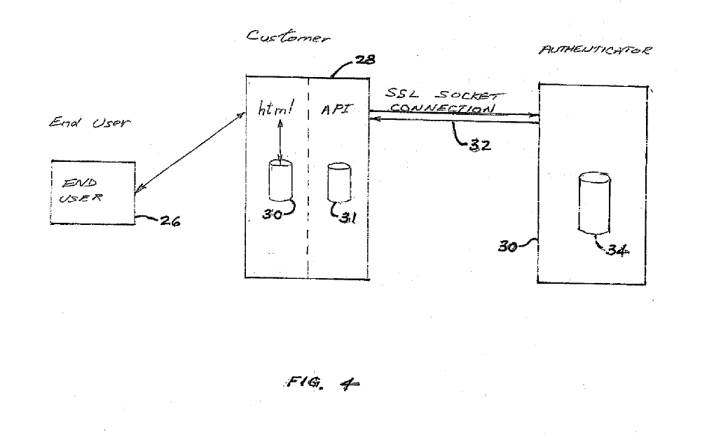

Referring to FIG. 3, a user can access over the Internet a bank 22 and the authentication system 10. In this case after the user inserts the bankcard number and password, the bank 22 provides a link to the authentication system 10 so that a user can deal directly with the authentication process.

Referring to FIG. 4, an end user 16 couples to a customer server 28 having a customer database 30. An application program interface (API) and database 32 are installed on the customer server 28 by the authenticator. Connection of the authentication system 30 to the customer is made by means of a secure socket layer (SSL) socket connection 32. The authentication system database 34 communicates with a number of modules in the authentication system 30.

In operation, the end user 26 communicates with the user database 30 and enters his/her user name and password. The database 31 associates the account with a secure identification number (SID) and generates a log. The authentication system 30 has an administration module, which resets the account using a scrambled account number that is generated from the SID by the SSL socket connection, a back end module that initiates and enters the transaction, a client module that delivers the question and a module that builds the question. The SID associated with each user is encrypted and shuffled on the Server side to form a secure internal ID denoted by the acronym SID. This prevents the association of answers to any user if unauthorized persons have accessed the database.

The system builds a unique profile for a user by employing simple language to create a memory that combines pleasant past experiences within the context of logging in. Users begin using the system by answering a few short training questions about their past (e.g., special places, food choices, etc.). The answers to these questions create a unique profile of the user. During subsequent logon sessions the user will receive additional training questions to evolve the profile and increase security protection. An important feature of this process is that by entering only a single letter from a selection grid as a response, the user does not divulge personal information. Obviously, other techniques could be used to achieve this anonymity such as true/false or multiple choice questions.

Once a profile has been established, a user can be authenticated against the profile. After the initial session, a user enters the first letter of his/her first and last name, his/her password and then is asked to answer test questions. Authentication of an individual user is achieved by comparing responses to a randomly chosen subset of test questions with those in the user's authentication profile. If the test question responses match the training question responses, then the user is authenticated and allowed access to the network, website or computer system. The access key is dynamic as the profile constantly changes and sessions are randomly created from that profile.

The objective in training is to create a unique instance of a memory related to a specific past experience/event using clear training questions. The questions are asked with key words designed to re-create that unique, specific past instance. The user generates a memory of the past and then answers the question. First the user is introduced to what will occur (e.g., questions will be asked about their past). The user is then introduced to how to deal with each question by using key words such as “think”, “picture” and “estimate”. Then the user is introduced to how to provide a response (e.g., select an option from a selection grid beneath each question). The following is an example of an initial training session screen:

Welcome to This Authentication Training Session
Answer quickly with the first, clear, vivid answer that comes to mind.
Answer selecting the first letter of a name or a number or if no answer
comes to mind, select “None” and continue.
Please follow these instructions when you read the questions:
Please read each question carefully.
To begin select “Enter”.
When you read the word ESTIMATE quickly provide a number that is
close to the actual number asked about the event.
When you read the word PICTURE imagine the details in that event.
When you read the word THINK go back in your mind to the age you
were at the time of the event.
You will be asked a series of easy questions about events in your life.
You already know the answers. For each question quickly answer with
the first response that comes to mind.

An example of a training question is the following:

THINK of an event that occurred to a friend a long time ago that made
you wish you could be him/her for one day.
PICTURE the friend you wished to be for one day and enter the first
letter of their first name.

After the first training session, the user will have established a profile, which can be used to authenticate him/her. The login instructions for authentication are as follows:

Please read each question carefully.
Answer quickly with the first clear, vivid answer that comes to mind.
If no answer comes to mind, simply select “None” and continue.
To begin select “Enter”.

While the initial session includes only training questions, subsequent sessions include a combination of test questions and training questions. This ensures that the profile is constantly expanded and changing.

Test questions are concerned with re-answering a question previously answered in training. The instructions for answering test questions are more abbreviated than the corresponding training questions. At test the user gets only part of the training question. The context is missing. For example, the test question corresponding to the above example of a training question is as follows:

PICTURE the friend you wished to be for one day and enter the first
letter of their first name.

By eliminating the context from the question, security is increased at the expense of accuracy. This problem is overcome by using key words between the test and training questions in order to successfully link the test response with the training experience.

Another example of a comparison of training and testing questions is as follows:

Training:

Re-create an early life experience
e.g., Think of one of the first occasions in your life where
you saw a fireworks display.
Picture watching fireworks long ago and enter the first
letter of the location where it happened.

The corresponding testing question is as follows:

Testing:

Re-create a previous training experience
e.g., Picture watching fireworks long ago and enter the first
letter of the location where it happened.

Key words such as “fireworks” and “location” specify which training response to replicate.

Obviously, it is important to know how accurately users can identify and answer test questions. For this reason each user accumulates a log of authentications (pass/fail sessions). From the log of authentications, the probability measure for the entire set of users, for example, in a company can be generated.

To see how the number of questions affects security, assume that the probability of guessing a question by guessing the correct letter of the alphabet is 1/26. If there are two questions then the probability of guessing both is 1/676 or 0.0015. Obviously, with just three questions the probability of guessing to authenticate a user increases to approximately 1 in 17,500.

An algorithm is used to ensure that every user session is different and adds new testing questions to the user password profile. Different combinations of train-test question pairs plus new training questions are added within each session.

If a user does not answer training questions he/she cannot advance through the authentication process. If the user does not answer a test question correctly he/she fails. A time out circuit may also be used providing a user with a maximum amount of time in which to answer all of the questions, such as 90 seconds. Once the 90 seconds is reached without successful completion of the answers to the questions, a failure is recorded. Once a user passes he/she may be issued a random password to clear that user at the login access point. Alternatively, the user may simply be granted access to the system, account, or device in question.

If a client requires only a moderate level of security then that client may choose to have users answer only two test questions per session. Other clients wishing a higher level of security and request their users answer more test questions before they are authenticated.

Since the user profiles are continuously changing and each session uses a different subset of the profiles, a user cannot share his/her answers because they do not know what responses will be required until the session happens. Moreover, since none of the questions involve personal identity information, even close family members will not know the answers to the testing questions.

The present system can be added to a host of different systems including verification of parties to a transaction and verification of a user in a user access request. Ordinarily a user name and password are stored on the system being accessed. An initial verification is made followed by a series of known questions which may include first name, last name, telephone and City. Preferably, rather than answering with the complete word only the first letter of the word is entered. This prevents complete biographical information from being stored, which could be used to identify a user. Once the initial verification has been completed, the user can engage the authentication system as described above.

The authentication can be used in combination with other authentication systems including two factor authentication solutions such as those of RSA Securities Inc. of Bedford, Mass., Verisign Inc. of Mountain View Calif., and Entrust of Addison, Tex.

Further examples of the first category of question, characterized by nostalgia in which the questions take the user back to vivid moments in their lives are shown below: These memories are individually important and vary for each user encountering the same question. The questions are categorized according to specified themes.

Theme: Family

1. What is the total number of brothers and sisters that both your parents had? If you are not sure, just give an estimate.
a. This allows for a number from 0 up to a maximum of about 20.
2. Many people have family members that they know very little about. Think about one family member that you know of, who sounds interesting, and who you would like to learn a lot more about. Enter the first letter of their name.
3. All families spend a lot of time preparing for special holidays. Think about the most important annual celebration in your home when you were a child and estimate how many days prior to that holiday did your family begin preparations.
4. Of all the friends that your parents have had over the years, which one do you think was the kindest to children? Imagine that person's face and enter the first letter of their name.

Theme: Location

5. Think about the house you lived in when you were 10 years old. If you allow for two people per bed in that house and one person per couch, what is the total number of people who could sleep in that house on a given night?
6. How you got to school partially depended on where you lived. Estimate in kilometers (or miles) how far your house was from the high school you attended on your first day of grade 8.

Theme: Education

7. You attended a variety of schools in your life. What is the name of the second school you attended? (Clearly picture that school in your head. Enter the first letter of its name.).
8. Everyone can remember at least one teacher who seemed to really care for students. Think back to elementary school and enter the first letter of the last name of one teacher who made a memorable impression on you.
9. What is the first book that you remember having read? Try to picture that book clearly in you mind. Not including words like “the” and “a” enter the first letter of that book's title.

Theme: Friends

10. We often lose track of friends from grade school, then are quite surprised when we meet them agains as adults. Think of one friend that you had before your 12^{th} birthday, who you would be surprised to see working where you do. Please try to imagine that perons's face as clearly as you can and enter the first letter of their last name.
11. Everyone has at least one relationship in high school that ended badly. Think of one person for whom this is true for you and enter the first letter of their name.
12. Sleepovers are an important part of childhood. Enter the first letter of the first name of one childhood friend who stayed the night at your house.

Theme: Celebrity

13. Think of a television show that you really enjoyed as a teenager. Try to picture in your mind one actor from that show and enter the first letter of their first name below.
14. As well as you can remember, what is the first musical recording that you owned. Try to “hear” the music in your head and enter the first letter of the name of the artist who recorded it.

Theme: Playthings

15. Think of a toy that was very special to you when you were a child. Perhaps you slept with it, or played with it all of the time. Try to get a clear picture of it in your mind and enter the first letter of its name.
16. What was the name of one specific toy that you had as a child that you wish that you still owned. Try to visualize the details of that toy and enter its first letter.
17 Was there ever a toy that one of your siblings or one of your friends had that you really wanted, but never received. Imagine that toy and enter the first letter of its name.

Theme: Comfort and Joy 18. When you were a child what was a food item that really made you happy? This could have been something sweet, a main course item or even a beverage. Try to imagine how it tasted, and enter the first letter of its name.

19. At times when you were alone as a child, what was one activity that you did that made you happy? Picture yourself doing that activity and enter the first letter of its name.

Theme: Pastimes

20. How many different teams (sports or other) have you been on between the ages of 5 and 18 years old?

The present technology uses memories and memory processes as an access key to access such things as computer systems. By basing the access on questions based upon unique life experiences one avoids the need to remembers passcodes, facts or data like pet names or mother's maiden name.

Accordingly, while this invention has been described with reference to illustrative embodiments, this description is not intended to be construed in a limiting sense. Various modifications of the illustrative embodiment will be apparent to those skilled in the art upon reference to this description. It is therefore contemplated that appended claims will cover any such modifications or embodiments as fall within the scope of the invention.

What is claimed is:

1. An authentication system for authenticating a user against a profile, comprising:
(a) a database having a plurality of training questions selected from the group consisting of a user's past life, mnemoseny and resonance and a corresponding testing question for each of said training questions stored thereon; and
(b) a central processing unit (CPU) coupled to said database and operative in both a training session and a testing session to select a sub-set of said training questions and to pose them sequentially to said user, store user responses to said subset of training questions in said user's profile and, in said testing session to select a subset of said testing questions and to pose them to said user, and to check responses of said user to said subset of testing questions against said user's profile, wherein each of said testing questions is based on a corresponding training question with or without a context.

2. The system according to claim 1, wherein key words in said training questions are replicated in said testing questions.

3. The system according to claim 1, including a password authentication system.

4. The system according to claim 1, wherein responses are made by selecting a letter on an alphabetic selection grid.

5. The system according to claim 1, wherein said database has a log of pass and fail recordals for each training/test pair and for each user.

6. The system according to claim 1, including a time out circuit monitoring and operative to limit the time available to answer said training and said testing questions.

7. The system according to claim 1, wherein each of said training questions follows a common format so that users may easily and consistently follow instructions.

8. The system according to claim 1, including a central processing unit (CPU) coupled to said database and operative to select a subset of said training and said testing questions wherein the testing questions in said subset of testing questions are randomly selected.

9. The system according to claim 1, wherein said training questions do not elicit any identifying information.

10. The system according to claim 1, including a performance monitor operative to record pass and fails for each one of said test questions for each user.

11. The system according to claim 1, wherein said CPU measures session initiation, time of sending questions, time of each answer, time of sending a random password which is issued after a session has been passed and time of using the random password

12. The system according to claim 1, wherein said training and testing questions create a feeling of nostalgia in a user.

13. The system according to claim 1, wherein said training and testing questions deal with things that have never been experienced or seen by anyone.

14. The system according to claim 1, wherein said training and testing questions employ resonance.

15. The system according to claim 1, wherein said training questions are based upon a user's past life and employ mnemoseny.

16. The system according to claim 1, wherein said training questions are based upon a user's past life and resonance.

17. The system according to claim 1, wherein said authentication system is used to enable a user to reset the user's own password.

18. A method of authentication, comprising:
(a) providing a database having training questions and testing questions relating to a user's life and life experiences, user responses to said training questions and identity information as part of a user profile, wherein each of said testing questions is based on a corresponding training question with or without a context; and
(b) during a training session, selecting a subset of said training questions from said database and displaying said training questions to the user;
(c) storing responses to said training questions in the user profile on said database;
(d) during a testing session, selecting a subset of said testing questions from said database and displaying said subset of said testing questions to the user;
(e) during said testing session, storing responses to said subset of said testing questions in the user profile on said database;
(f) checking a response to each one of said testing questions of said subset of testing questions against responses stored in said user profile to determine if each one of said responses to said testing question in said subset of testing questions is a pass or fail.

19. The method according to claim 18, including terminating said session if any of said responses to said subset of testing questions is a fail.

20. The method according to claim 18, including the same key words are present in both said training and testing questions.

21. The method according to claim 18, including limiting a time during which each of said training questions is displayed so that a user is prevented from over-elaborating an experience.

22. The method according to claim 18, wherein each of said training questions follows the same format so that users may easily and consistently follow instructions.

23. The method according to claim 18, wherein each subset of testing questions is randomly generated.

24. The method according to claim 18, wherein each testing session is different.

25. The method according to claim 18, wherein said training questions do not elicit any identifying information.

26. The method according to claim 18, including monitoring pass and fails for each test question per each individual user.

27. The method according to claim 18, including storing time of initiation of a session user, time questions are sent, time of each answer to the questions, time of sending of a random password which is issued after a session has been passed, and time of using the random password.

28. The method according to claim 18, including generating a random password to clear a user at a login access point if that user passes the testing session.

29. The method according to claim 18, wherein said training and testing questions create a feeling of nostalgia in a user.

30. The method according to claim 18, wherein said training and testing questions deal with things that have never been experienced or seen by anyone.

31. The method according to claim 18, wherein said training and testing questions employ resonance.

32. The method according to claim 18, wherein said method of authentication is used to allow a user to reset that user's own password.
